(19) United States
(12) Patent Application Publication
(10) Pub. No.: US 2008/0242394 A1
(43) Pub. Date: Oct. 2, 2008

(54) GAMING MACHINE DETERMINING A SYMBOL TO BE REARRANGED IN EVERY GAME

(75) Inventor: Hiro SAKUMA, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp., Tokyo (JP)

(21) Appl. No.: 11/970,855

(22) Filed: Jan. 8, 2008

(30) Foreign Application Priority Data
Jan. 10, 2007 (JP) 2007-002713

(51) Int. Cl. A63F 13/00

(52) U.S. Cl. 463/20

(57) ABSTRACT

A gaming machine includes a display device, a memory, an input device and a controller. The display device displays symbols and columns where the symbols are independently scrolled. The memory stores symbol data. The controller is configured with logic to: (a) start a game, and cause the game to be switched to a predetermined game state when a game result satisfies a predetermined condition; (b) determine in the switched game state whether a predetermined specific symbol has been arranged in a window of a first column that is first controlled to be stationary; (c) arrange a symbol in a window of another column when the specific symbol has been arranged in the window of the first column, and when a winning combination does not occur in combination with the specific symbol in the first column, cause another column to be scrolled again such that the winning combination is effective.

This application is based on and claims the benefit of priority from Japanese Patent Application No. 2007-002713, filed on 10 Jan. 2007, the content of which is incorporated herein by reference.

### BACKGROUND OF THE INVENTION

1. Field of the Invention

The present invention relates to a gaming machine which determines a symbol to be rearranged in every game thereof.

2. Related Art

Conventionally, regarding a slot machine, which is a type of gaming machine, a game is generally started by inserting a game medium such as coins into the gaming machine. Then, the slot machine displays an image of a symbol line which is rotated in a predetermined area of the gaming machine. After a predetermined amount of time elapses, the slot machine displays an image of the symbol line which is stopped. Finally, the slot machine awards a prize to a player based on the combination of the stopped symbols. Whether the combination which provides a prize has been formed or not is generally determined based on whether or not a predetermined number of the same type of symbols (for example, “Cherry”, “7”, etc.) is arranged along a predetermined active pay line. In addition, U.S. Pat. No. 6,093,102 discloses a slot machine which provides a prize to a player when a combination of symbols rearranged on an active pay line matches any one of combinations among predetermined winning symbols.

### SUMMARY OF THE INVENTION

However, when the combination of symbols rearranged on the active pay line does not match any one of the combinations among predetermined winning symbols, a prize is not awarded to the player, and thus the player never obtains any opportunity to receive the prize again.

The present invention has an object of providing a gaming machine which can further improve entertainment properties.

In an aspect of the present invention, a gaming machine is provided, which includes a display device, a memory, an input device and a controller. The display device displays a plurality of types of symbols and a plurality of columns where the plurality of types of symbols is independently scrolled. The memory stores symbol data corresponding to the plurality of types of symbols. The controller is configured with logic to: (a) start a game, receiving a signal from the input device, and cause the game to be switched to a predetermined game state when a game result satisfies a predetermined condition; (b) determine in the switched game state whether a predetermined specific symbol has been arranged in a window of a first column that is first controlled to be stationary; (c) arrange a symbol different from the specific symbol in a window of another column when the specific symbol has been arranged in the window of the first column, and when a winning combination does not occur in combination with the specific symbol in the first column, cause another column to be scrolled again such that the winning combination is effective.

According to the gaming machine employing the abovementioned configuration, when a CPU 106 proceeds to a predetermined game status, the CPU 106 determines whether a specified symbol, which is predetermined among the plurality of types of symbols, is rearranged in a display window of a first scroll line which is stopped initially among a plurality of scroll lines. When the CPU 106 determines whether the specified symbol is rearranged in the display window of the first scroll line, the CPU 106 rearranges any symbol among a plurality of symbols, which is different from the specified symbol, in the display window of a second scroll line which is different from the first scroll line. When it is not a winning combination in combination with the specified symbol on the first scroll line, the CPU 106 scrolls again the second scroll line so that it becomes the winning combination in combination with the specified symbol on the first scroll line.

Thus, in the predetermined game status, when the specified symbol is rearranged in the display window of the first scroll line, which is stopped initially among a plurality of scroll lines, the CPU 106 rearranges any symbol among a plurality of symbols, which is different from the specified symbol, in the display window of the second scroll line. When it is not a winning combination in combination with the specified symbol on the first scroll line, the CPU 106 scrolls the second scroll line again so that it becomes the winning combination in combination with the specified symbol on the first scroll line. Consequently, the player can get the award corresponding to the specified symbol.

As a result, even if a winning combination comprising the specified symbol has not been formed, scrolling is performed again, thereby forming a winning combination having the specified symbol. Consequently, an opportunity to get a prize would be provided to the player. Thus, the player can enjoy the game with further entertainment properties.

In another aspect of the present invention, a gaming machine is provided, which includes a display device, a memory and a controller. The display device displays a plurality of types of symbols and a plurality of columns where the plurality of types of symbols is independently scrolled. The memory stores symbol data corresponding to the plurality of types of symbols. The controller is configured with logic to: (a) start a game; (b) cause the game to be switched to a predetermined game state depending on a result of the game; (c) select specific symbol data from the symbol data stored in the memory when the game has been switched to the predetermined game state; (d) cause the display device to display a scrolled image of the plurality of types of symbols for each of the plurality of columns; (e) when the specific symbol data is arranged in a window of a first column that is first controlled to be stationary, determine whether the specific symbol has been arranged in a window of each column other than the first column; and (f) when the specific symbol is arranged in the window of each column other than the first column, provide an award in accordance with the specific symbol.

According to the gaming machine employing the abovementioned configuration, when a CPU 106 proceeds to a predetermined game status, the CPU 106 determines a specified symbol data and scrolls plural types of symbols in increments of a plurality of scroll lines. When the specified symbol is rearranged in the display window of the first scroll line which is stopped initially among a plurality of scroll lines, the CPU 106 determines whether specified symbol is arranged in each of the second scroll line other than the first scroll line. When the specified symbol is rearranged in each of the display window of the other scroll lines, the CPU 106 provides a prize corresponding to the specified symbols.

Thus, in the predetermined game status, the specified symbols are determined and the determined specified symbols are rearranged in the display window on the first scroll line which is stopped initially among a plurality of scroll lines, the player can get a prize corresponding to the specified symbol.

As a result, since the specified symbol is determined in the predetermined state of a game, the player can not predict which symbol is rearranged so that the prize corresponding to the specified symbol is given to the player. Thus, the player can enjoy the game with further entertainment properties.

In still another aspect of the present invention, a gaming machine is provided, which includes a display device, a memory and a controller. The display device displays a plurality of types of symbols, a plurality of columns where the plurality types of symbols is independently scrolled and predetermined pay lines. The memory stores symbol data corresponding to the plurality of types of symbols. The controller is configured with logic to: (a) start a game; (b) cause the game to be switched to a predetermined game state depending on a result of the game; (c) select specific symbol data from the symbol data stored in the memory when the game has been switched to the predetermined game state; (d) cause the display device to display a scrolled image of the plurality of types of symbols for each of the plurality of columns; (e) when the specific symbol data is arranged in a window of a first column that is first controlled to be stationary, determine whether the specific symbol has been arranged in a window of each column other than the first column; (f) when the specific symbol is arranged in the window of each column other than the first column, cause the display device to display a rescrolled image of each column other than the first column such that the specific symbol is rearranged on a pay line on which the specific symbol is arranged in the window of the first column; (g) cause the display to stop rescrolling; and (h) provide an award in accordance with the specific symbol.

According to the gaming machine employing the abovementioned configuration, when a CPU 106 proceeds to a predetermined game status, the CPU 106 determines a specified symbol data and scrolls plural types of symbols in increments of a plurality of scroll lines. When the specified symbol is rearranged in the display window of the first scroll line which is stopped initially among a plurality of scroll lines, the CPU 106 determines whether specified symbol is arranged in each of the second scroll line other than the first scroll line. When the specified symbol is rearranged in each of the display window of the second scroll lines, the second scroll line is scrolled again in order to rearrange the specified symbol rearranged in each display window of the other scroll windows on an active pay line corresponding to the display position of the specified symbol which is rearranged in the display window of the first scroll line, thereby giving the prize corresponding to the specified symbol.

Thus, in the predetermined game status, the specified symbols are determined and the determined specified symbols are rearranged in the display window on the first scroll line which is stopped initially among a plurality of scroll lines, the second scroll line is scrolled again in order to rearrange the specified symbol rearranged in each display window of the other scroll windows on an active line corresponding to the display position of the specified symbol which is rearranged in the display window of the first scroll line, thereby giving the prize corresponding to the specified symbol.

As a result, since the specified symbol is determined in the predetermined state of a game, the player can not predict which symbol is controlled so as to be rearranged on an active line. Thus, the player can enjoy the game with further entertainment properties.

In yet another aspect of the present invention, a gaming machine is provided, which includes a display device, a memory and a controller. The display device displays a plurality of types of symbols and a plurality of columns where the plurality of types of symbols is independently scrolled. The memory stores symbol data corresponding to the plurality of types of symbols. The controller is configured with logic to: (a) start a game; (b) cause the game to be switched to a predetermined game state depending on a result of the game; (c) select specific symbol data from the symbol data stored in the memory when the game has been switched to the predetermined game state; (d) cause the display device to display a scrolled image of the plurality of types of symbols for each of the plurality of columns; (e) when the specific symbol data is arranged in a window of a first column that is first controlled to be stationary, determine whether the specific symbol has been arranged in a window of each column other than the first column; and (f) when the specific symbol is arranged in the window of each column other than the first column, cause the display device to display an image of pay line that connects each position of the specific symbol in the window of each column and provide an award in accordance with the specific symbol.

According to the gaming machine employing the abovementioned configuration, when a CPU 106 proceeds to a predetermined game status, the CPU 106 determines a specified symbol data and scrolls plural types of symbols in increments of a plurality of scroll lines. When the specified symbol is rearranged in the display window of the first scroll line which is stopped initially among a plurality of scroll lines, the CPU 106 determines whether specified symbol is arranged in each of the second scroll line other than the first scroll line. When the specified symbol is rearranged in each of the display window of the second scroll lines, a line linking display positions of the specified symbol rearranged in each of a plurality of scroll lines is displayed as an active pay line, thereby giving the prize corresponding to the specified symbol.

Thus, in the predetermined game status, the specified symbols are determined and the determined specified symbols are rearranged in the display window on the first scroll line which is stopped initially among a plurality of scroll lines, a line linking display positions of the specified symbol rearranged in each of a plurality of scroll lines is displayed as an active pay line, thereby giving the prize corresponding to the specified symbol.

In a further aspect of the present invention, a gaming machine is provided, in which the predetermined game state is a bonus game.

### BRIEF DESCRIPTION OF THE DRAWINGS

FIG. 1 is a flowchart showing the flow of a game which is executed in a slot machine according to the preferred embodiment of the present invention;

FIG. 2 is an external perspective view showing the slot machine according to the preferred embodiment of the present invention;

FIG. 3 is an enlarged front view showing an enlarged view of a display region of the slot machine according to the preferred embodiment of the present invention;

FIG. 4 is a block diagram showing a controller of the slot machine according to the preferred embodiment of the present invention;

FIG. 5 is a block diagram showing a display/input controller of the slot machine according to the preferred embodiment of the present invention;

FIG. 6 is a diagram showing a symbol line represented on each video reel according to a preferred embodiment of the present invention;

FIG. 7 is a diagram showing a symbol arrangement table according to the preferred embodiment of the present invention;

FIG. 8 is a flowchart showing a flow for processing a basic game executed by the slot machine according to the preferred embodiment of the present invention;

FIG. 9 is a diagram showing a random number table for a basic game according to the preferred embodiment of the present invention;

FIG. 10 is a diagram showing a payout table for a basic game according to the preferred embodiment of the present invention;

FIG. 11 is a flowchart showing a flow for bonus game processing 1 executed by the slot machine according to the preferred embodiment of the present invention;

FIG. 12 is a diagram showing a random number table for a bonus game according to the preferred embodiment of the present invention;

FIG. 13 is a diagram showing a payout table for a bonus game according to the preferred embodiment of the present invention;

FIG. 14 is a diagram showing a random number table for determining a specified symbol according to the preferred embodiment of the present invention;

FIG. 15 is a diagram showing a random number table for determining rearrangement of a specified symbol according to the preferred embodiment of the present invention;

FIGS. 16 to 18 are examples of display images according to the preferred embodiment of the present invention;

FIG. 19 is a flowchart showing a flow for bonus game processing 2 executed by the slot machine according to the preferred embodiment of the present invention; and

FIGS. 20 and 21 are examples of display images according to the preferred embodiment of the present invention.

### DETAILED DESCRIPTION OF THE INVENTION

The embodiments of the present invention are hereinafter described in detail with reference to the attached drawings.

A slot machine 13 according to the present invention is provided with a liquid crystal display 30 for displaying a plurality of types of symbols and a plurality of scroll lines which each of the plurality of types of symbols is variably displayed separately, RAM 110 for storing a symbol data corresponding to the plurality of types of symbols, and a start switch 25 for starting a game. A CPU 106 starts the game by the start switch 25 and proceeds to a predetermined game status when a predetermined condition regarding the game contents is satisfied. The CPU 106 determines whether a specified symbol, which is predetermined among the plurality of types of symbols, is rearranged in a display window of a first scroll line that is stopped initially among a plurality of scroll lines. When the CPU 106 determines whether the specified symbol is rearranged in the display window of the first scroll line, the CPU 106 rearranges any symbol among a plurality of symbols, which is different from the specified symbol, in the display window of a second scroll line which is different from the first scroll line. When it is not a winning combination in combination with the specified symbol on the first scroll line, the CPU 106 scrolls again the second scroll line so that it becomes the winning combination in combination with the specified symbol on the first scroll line.

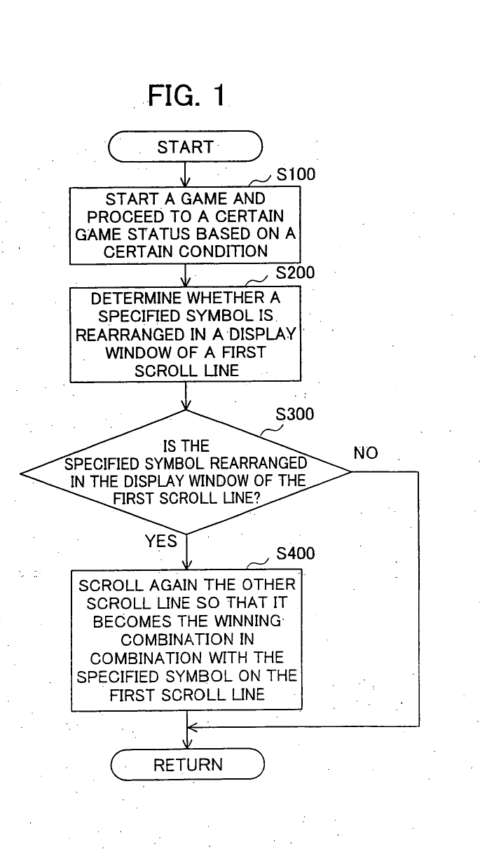

As shown in FIG. 1 (the details are described later), the CPU 106 starts a game by the start switch 25 and proceeds to a predetermined game status when a predetermined condition regarding the game contents is satisfied (Step S100). The CPU 106 determines whether a specified symbol, which is predetermined among the plurality types of symbols, is rearranged in a display window of a first scroll line that is stopped initially among a plurality of scroll lines (Step S200). When the CPU 106 determines whether the specified symbol is rearranged in the display window of the first scroll line (YES determination in the Step S300), the CPU 106 rearranges any symbol among a plurality of symbols, which is different from the specified symbol, in the display window of a second scroll line which is different from the first scroll line. When it is a winning combination in combination with the specified symbol on the first scroll line, the CPU 106 scrolls the second scroll line again so that it becomes the winning combination in combination with the specified symbol on the first scroll line (Step S400).

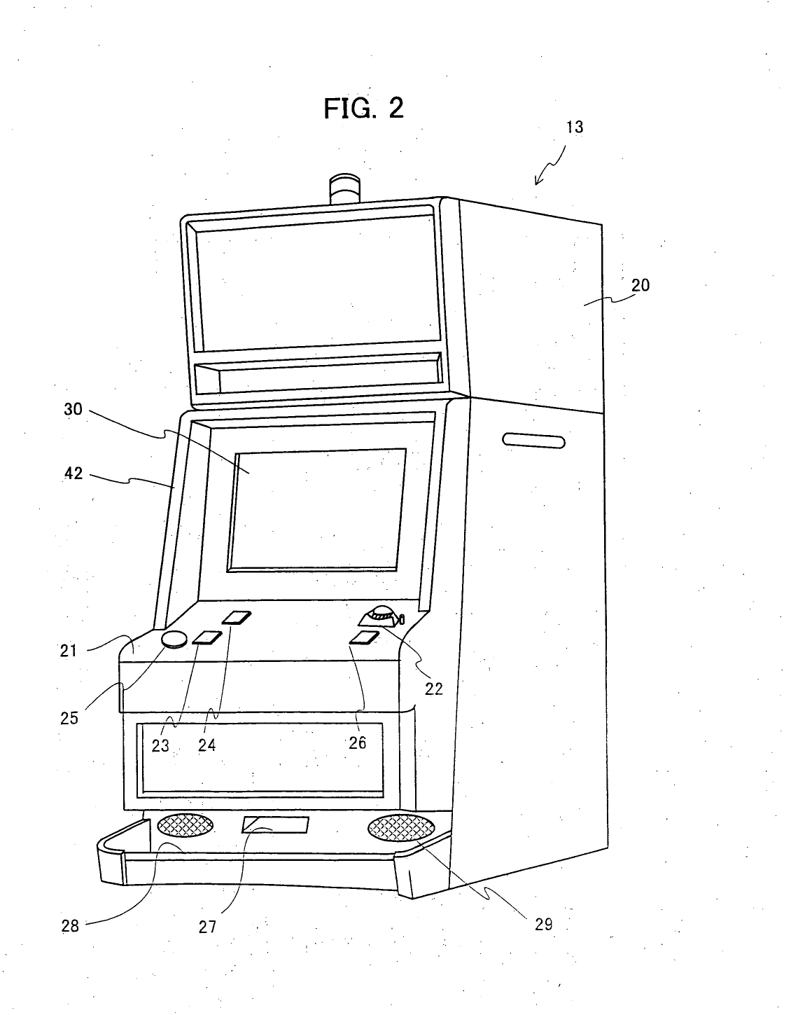

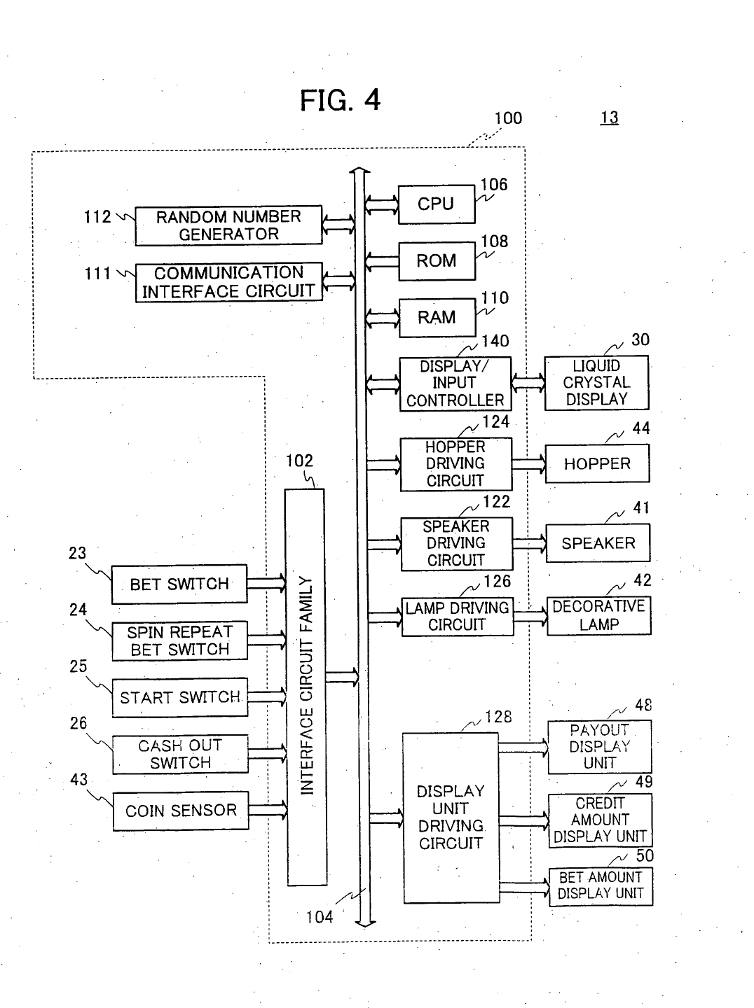

FIG. 2 is a perspective diagram illustrating the slot machine 13 according to the embodiment of the present invention. The slot machine 13 includes a cabinet 20 and a main door 42. The cabinet 20 has a structure in which the face facing the player is open. The cabinet 20 includes various kinds of components. Such components include: a controller 100 (see FIG. 4) for electrically controlling the slot machine 13; a hopper 44 for controlling insertion, retaining, and paying out of coins (game medium) (see FIG. 4), etc. The game medium is not restricted to coins. In addition, examples of such game media include medals, tokens, electronic money or electronic value information (credit) having the same value.

The main door 42 is a member that serves as a cover of the cabinet 20, which protects the internal components stored in the cabinet 20 from being exposed to the outside. The main door 42 includes the liquid crystal display 30 at substantially the center thereof.

The liquid crystal display 30 is provided for displaying various kinds of images with respect to the game such as images for visual effects. Such a configuration allows the player to advance the game while visually confirming various kinds of images displayed on the aforementioned liquid crystal display 30. The liquid crystal display 30 includes a transparent liquid crystal panel 34. The transparent liquid crystal panel 34 has a function of switching a part of or the entire area of the liquid crystal panel 34 between a transparent mode and an opaque mode, and a function of displaying various kinds of images.

In a configuration in which the slot machine 13 includes video reels, five virtual reels are displayed on the liquid crystal display 30. It should be noted that the term “video reel” as used here represents a mechanism for displaying a reel on the liquid crystal display 30 in the form of an image. Multiple kinds of symbols necessary for the basic game include “BONUS”, “WILD”, “TREASURE BOX”, “GOLDEN MASK”, “HOLY CUP”, “COMPASS & MAP”, “SNAKE”, “A”, “K”, “Q”, “J”, and “10”. With such an arrangement, the liquid crystal display 30 displays these symbols with an image as if the reel were rotating.

The slot machine 13 includes a substantially horizontal operation unit 21 below the liquid crystal display 30. Furthermore, a coin insertion opening 22 is provided on the right side of the operation unit 21, which allows the player to insert coins. A bet switch 23 and a spin repeat bet switch 24 are provided on the left side of the operation unit 21. The bet switch 23 selects the amount of the coins (game medium) bet to lines (hereinafter merely called “an active pay line” or “an effective line”) which determines that any of lines L1, L2, L3, L4, L5, L6, L7, L8, and L9 for giving nine awards which are described later is set to be active pay lines or not, and which gives the prize which is activated. The spin repeat bet switch 24 performs a game again without changing the amount of coins bet on the winning line from the previous game. Such an arrangement allows the player to set the amount of coins bet to the active pay line by performing a pushing operation on either the bet switch 23 or the spin repeat bet switch 24.

With the aforementioned operation unit 21, a start switch 25 is provided on the left side of the bet switch 23, which allows the player to input a start operation instruction for the basic game in increments of games. Upon performing a pushing operation on either the start switch 25 or the spin repeat bet switch 24, which serves as a trigger to start the game, the aforementioned five mechanical reels 3A to 3E start to rotate.

A cash out switch 26 is provided near the coin insertion opening 22 on the operation unit 21. Upon the player pushing the cash out switch 26, the inserted coins are paid out from a coin payout opening 27 provided at a lower portion of the front face of the main door 42. The coins thus paid out are retained in a coin tray 28. Furthermore, the coin payout opening 27 is provided on the upper side of the coin tray 28, with sound transmission openings 29 provided to both the left and right of the coin payout opening 27. Here, the sound transmission openings 29 are provided for transmitting sound effects generated by a speaker 41 (see FIG. 4) stored within the cabinet 20.

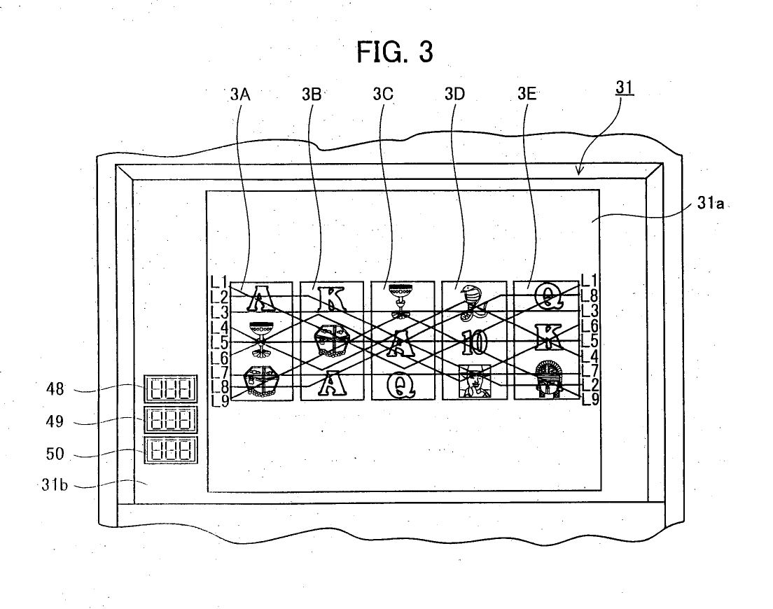

FIG. 3 is an enlarged view illustrating the display region of the slot machine 13. The liquid crystal display 30 of the slot machine 13 includes a front panel 31 and the transparent liquid crystal panel 34 provided to the rear face of the front panel 31. The front panel 31 includes a transparent display screen 31a and a design formation area 31b where designs have been formed. Such an arrangement allows the player to visually confirm the image information displayed on the transparent liquid crystal panel 34 provided to the rear ace of the front panel 31 through the display screen 31a of the front panel 31. In a case where an arrangement in which the slot machine 13 includes video reels, the transparent liquid crystal panel 34 in an opaque state may display the reels in the form of an image. In addition, an ordinary liquid crystal panel may be employed instead of the transparent liquid crystal panel 34.

Furthermore, various kinds of display units, i.e., a payout display unit 48, a credit amount display unit 49, and a bet amount display unit 50, are provided on the left side of the rear face of the liquid crystal display 30. It should be noted that the design formation area 31b of the front panel 31 is formed having a transparent portion that covers the top faces of these display units 48 through 50, thereby allowing the player to visually confirm the contents displayed on the aforementioned display units 48 through 50.

The slot machine 13 has the nine lines L1 through L9 for providing prizes as shown in FIG. 3. Each of the lines L1 through L9 for providing prizes is formed such that it extends so as to pass through one of the symbols for each of the mechanical reels 3A to 3E when the five video reels have stopped.

Upon pushing the aforementioned bet switch 23 once, the line L3 for providing a third prize, the line L5 for providing a fifth prize, and the line L7 for providing a seventh prize, are set to be active pay lines, and one coin is input as a credit medal, for example.

Furthermore, upon pushing the aforementioned bet switch 23 twice, the line L1 for providing a first prize, the line L4 for providing a fourth prize, and the line LB for providing an eighth prize, are set to be active pay lines, in addition to the aforementioned three lines, and two coins are input as credit medals, for example.

Moreover, upon pushing the aforementioned bet switch 23 three times, the line L2 for providing a second prize, the line L6 for providing a sixth prize, and the line L9 for providing a ninth prize, are set to be active pay lines, in addition to the aforementioned six lines, and three coins are input as credit medals, for example.

The payout display unit 48 is a component for displaying the amount of the coins paid out when a combination of the symbols has been established along any one of the active lines for providing a prize. The credit amount display unit 49 is a component for displaying the amount of the coins retained in the slot machine 13 in the form of credits. The bet amount display unit 50 is a component for displaying the bet amount which is the amount of coins bet on the aforementioned active pay lines. Each of the display units 48 through 50 includes a seven-segment display device. Alternatively, each of the display devices 48 through 50 may be displayed on the transparent liquid crystal panel 34 in the form of an image.

FIG. 4 is a block diagram illustrating an electric constitution of the controller 100 of the slot machine 13 having video reels. As shown in FIG. 4, the controller 100 of the slot machine 13 is a micro computer, and includes an interface circuit group 102, an input/output bus 104, a CPU 106, ROM 108, RAM 110, a communication interface circuit 111, a random number generator 112, a speaker driving circuit 122, a hopper driving circuit 124, a display unit driving circuit 128, and a display/input controller 140.

The interface circuits 102 are electrically connected with the input/output bus 104, which carries out input and output of data signals or address signals for CPU 106.

The start switch 25 is electrically connected with the interface circuits 102. In the interface circuits 102, a start signal generated by the start switch 25 is converted into a predetermined form of signal to be supplied to the input/output bus 104.

Furthermore, the bet switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuits 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

When the start switch 25 accepts an instruction for starting a basic game, the CPU 106 reads a basic game program and executes the basic game. The basic game program has been programmed so as to instruct the CPU 106 to perform the following operations of displaying an image of the five video reels commencing to scroll the symbols on the five video reels on the liquid crystal display 30 via the display/input controller 140; then displaying an image of the five video reels stopping such that the combination of the symbols on these five video reels is rearranged, upon which a new combination of the symbols is made along the active pay lines. In a case where a particular combination of the symbols for providing an award has been made along any one of the active pay lines when they are stationary, the CPU 106 pays out a predetermined amount of coins corresponding to the particular combination for providing the prize.

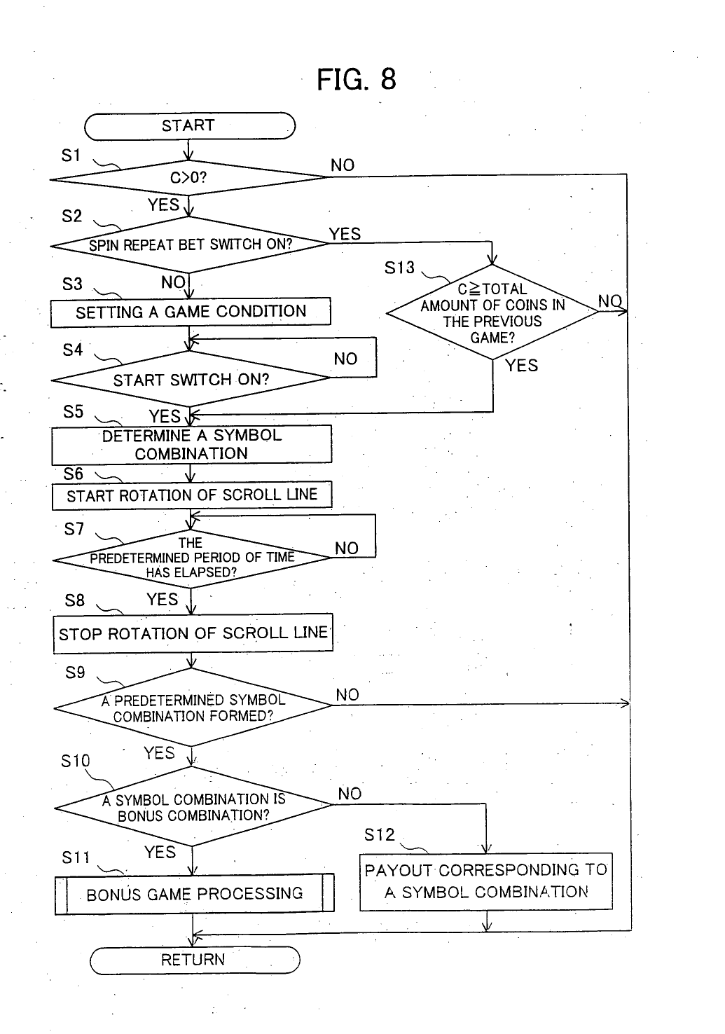

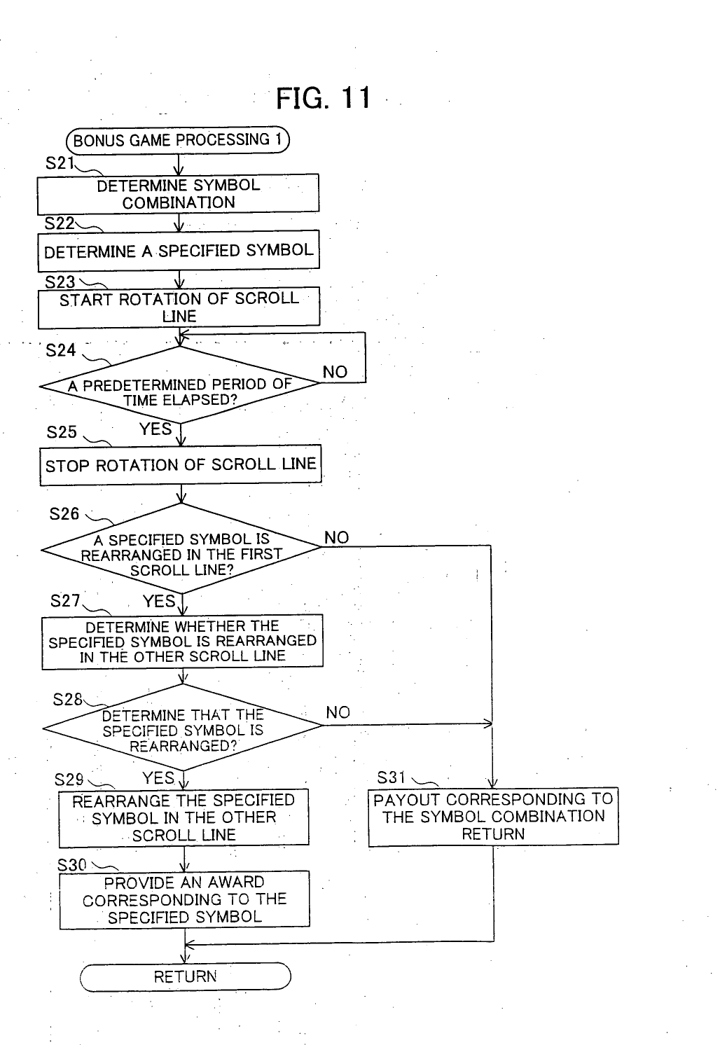

The ROM 108 stores: a control program for central control of the slot machine 13; a program for executing a routine shown in FIG. 8 and FIG. 11 (which is referred to as the “routine execution program” hereafter); initial data for executing the control program; and various data tables used for determination processing. It should be noted that the routine execution program includes the aforementioned basic game program and the like. The RAM 110 temporarily stores flags, variables, etc., used for the aforementioned control program.

Furthermore, a communication interface circuit 111 is connected to the input/output bus 104. The communication interface circuit 111 is a circuit for communicating with a server, etc., via various kinds of communication networks including a public telephone line network, LAN, etc.

The random number generator 112 for generating a random number is connected to the input/output bus 104. The random number generator 112 generates random numbers in a predetermined range of “0” to “65535” (the sixteenth power of two minus one), for example. Alternatively, an arrangement may be made in which the CPU 106 generates a random number by computation.

The display unit driving circuit 128 for driving each of the aforementioned display units 48 through 50 is connected to the input/output bus 104. The CPU 106 controls the operation of each of the aforementioned display units 48 through 50 via the display unit driving circuit 128 according to an occurrence of a predetermined event.

The speaker drive circuit 122 for the speakers 41 is also electrically connected with the input/output bus 104. The CPU 106 reads the sound data stored in the ROM 108, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon reception of a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

The display/input controller 140 is connected to the input/output controller 140. The CPU 106 creates an image display command corresponding to the state and results of the game, and outputs the image display command thus created to the display/input controller 140 via the input/output bus 104. Upon reception of the image display command input from the CPU 106, the display/input controller 140 creates a driving signal for driving the liquid crystal display 30 according to the image display command thus input, and outputs the driving signal thus created to the liquid crystal display 30. As a result, a predetermined image is displayed on the transparent liquid crystal panel 34 of the liquid crystal display 30. The display/input controller 140 transmits the signal input through the touch panel 32 provided on the liquid crystal display 30 to the CPU 106 via the input/output bus 104 in the form of an input signal.

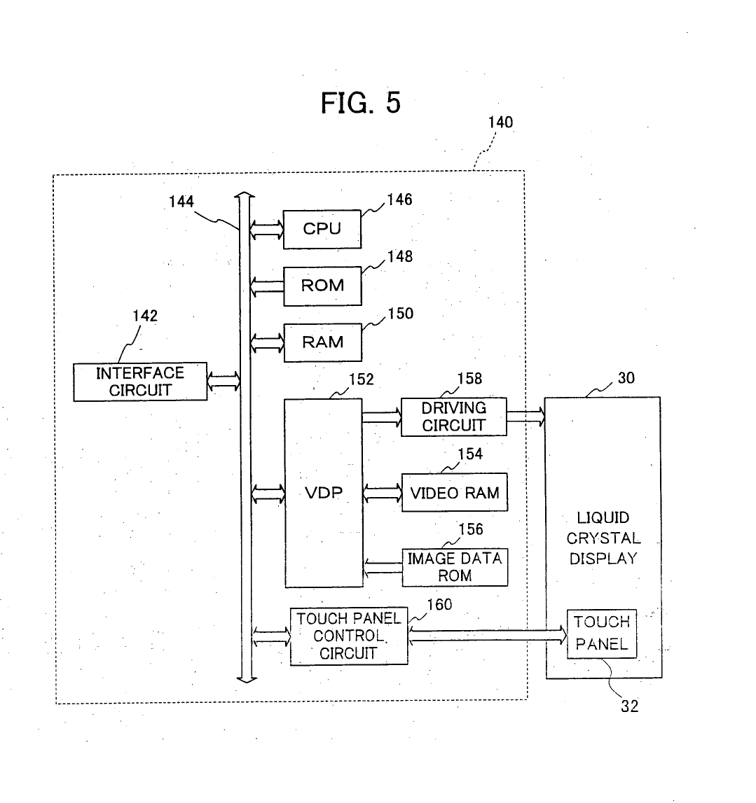

FIG. 5 is a block diagram illustrating the electric constitution of display/input controller 140 of the slot machine 13. The display/input controller 140 of the slot machine 13 is a sub-microcomputer for performing image display processing and input control for the touch panel 32. The display/input controller 140 includes an interface circuit 142, an input/output bus 144, a CPU 146, ROM 148, RAM 150, a VDP 152, video RAM 154, image data ROM 156, a driving circuit 158, and a touch panel control circuit 160.

The interface circuit 142 is connected to the input/output bus 144. The image display command output from the CPU 106 of the aforementioned controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program for generating a driving signal, which is to be supplied to the liquid crystal display 30, according to an image display command received from the CPU 106 of the aforementioned controller 100. On the other hand, the RAM 150 stores flags and variables used in the aforementioned display control program.

The VDP 152 is connected to the input/output bus 144. The VDP 152 includes a so-called sprite circuit, a screen circuit, a palette circuit, etc., and can perform various kinds of processing for displaying images on the liquid crystal display 30. With such an arrangement, the components connected to the DVP 152 include: the video RAM 154 for storing image data according to the image display command received from the CPU 106 of the aforementioned controller 100; and the image data ROM 156 for storing various kinds of image data including the aforementioned image data for visual effects, etc. Furthermore, the driving circuit 158 for outputting a driving signal for driving the liquid crystal display 30 is connected to the VDP 152.

The aforementioned CPU 146 instructs the video RAM 154 to store the image data which is to be displayed on the liquid crystal display 30 according to the image display command received from the CPU 106 of the aforementioned controller 100 by reading out the display control program stored in the ROM 148 and by executing the program thus read. Examples of the image display commands include various kinds of image display commands including the aforementioned image display commands for visual effects, etc.

The image data ROM 156 stores various kinds of image data including the aforementioned image data for visual effects, etc.

The touch panel control circuit 160 transmits the signals input via the touch panel 32 provided on the liquid crystal display 30 to the CPU 106 via the input/output bus 144 in the form of an input signal.

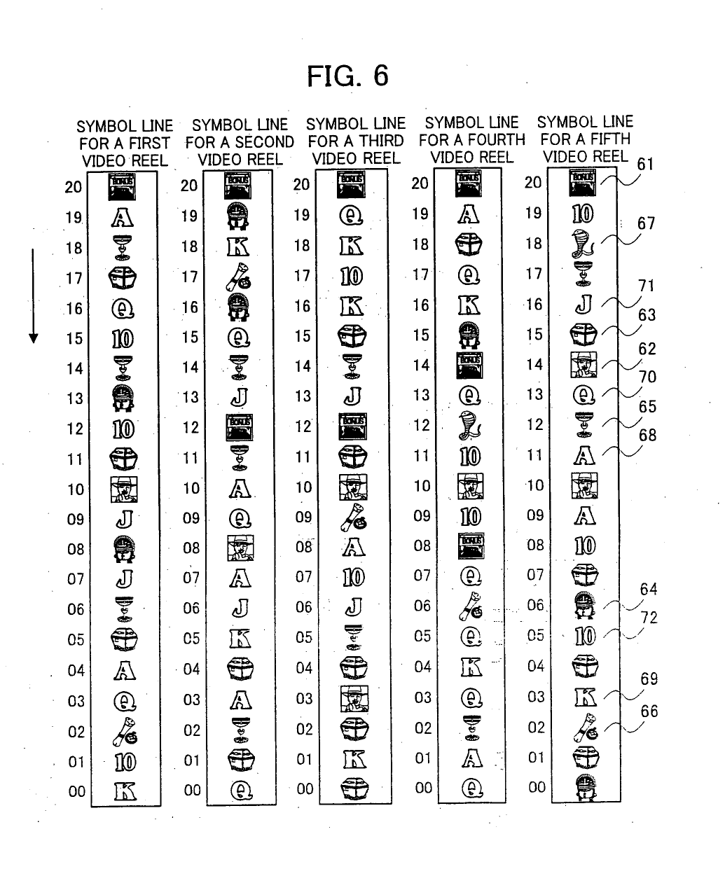

FIG. 6 shows symbol lines on which 21 symbols arranged on each video reel 3A to 3E are represented. The symbol line for the first video reel corresponds to the video reel 3A. The symbol line for the second video reel corresponds to the video reel 3B. The symbol line or the third video reel corresponds to the video reel 3C. The symbol line for the fourth video reel corresponds to the video reel 3D. The symbol line for the fifth video reel corresponds to the video reel 3E.

Referring to FIG. 6, a code number of “00”-“20” is referred to for each symbol of video reels 3A to 3E. These code numbers are converted to be data in a data table so as to be stored in the aforementioned ROM 108 (FIG. 4).

On each video reel 3A to 3E, a symbol line is represented with symbols as follows: “Bonus” symbol (symbol 61) (hereafter, “Bonus”), “Wild” symbol (symbol 62) (hereafter, “Wild”), “Treasure Chest” symbol (symbol 63) (hereafter, “treasure chest”), “Golden Mask” symbol (symbol 64) (hereafter, “Golden Mask”)”, “Holy Grail” symbol (symbol 65) (hereafter, “Holy Grail”), “Compass and Map” symbol (symbol 66) (hereafter, “Compasses and Map”), “Snake” symbol (symbol 67) (hereafter, “Snake”), “Ace” symbol (symbol 68) (hereafter, “Ace”), “King” symbol (symbol 69) (hereafter, “King”), “Queen” symbol (symbol 70) (hereafter, “Queen”), “Jack” symbol (symbol 71) (hereafter, “Jack”), and “10” symbol (symbol 72) (hereafter, “10”). The symbol line of each video reel 3A to 3E displays an image moving to the direction of the arrow in FIG. 8 (moving below from the top) by displaying an image that the each video reel 3A to 3E is being rotated in forward direction.

Here in the present embodiment, each combination of “Bonus”, “Wild”, “Snake”, “Treasure Chest”, “Golden Mask”, “Holy Grail”, “Compass and Map”, “Ace”, “King”, “Queen”, “Jack” and “10” is set as a prize combination. A combination (combination data) is control information which relates credits awarded to a player (the amount of payout of coins) to a combination of a prize combination, and which is used for stop control of each video reel 3A through 3E, change (shift) of a game state, awarding of coins, and the like.

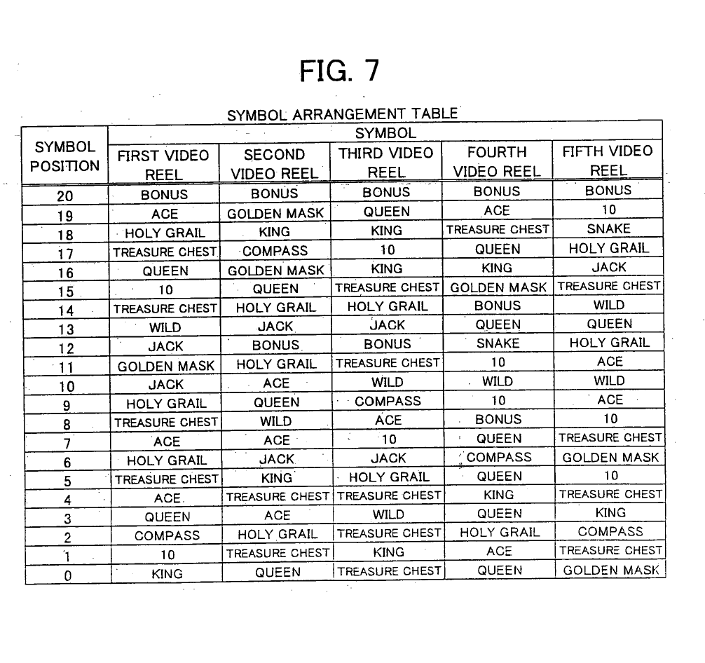

FIG. 7 shows a symbol arrangement table. The symbol arrangement table relates the code number indicating the position of each symbol which constitutes the aforementioned symbol lines to each symbol of the respective video reels 3A to 3E, and then, registers thereof. In addition, the first video reel through the fifth video reel corresponds to the video reels 3A to 3E, respectively. In other words, the symbol arrangement table includes symbol information corresponding to the symbol position (the code number) of video reels 3A to 3E.

FIG. 8 is a flow chart illustrating a flow of the processing operation in the game machine 13 executed by the controller 100 of the game machine 13. The processing operation is called from a main program for the slot machine 13 at a predetermined timing, and then executed.

A description is provided below regarding a case in which the slot machine 13 has been activated beforehand. Furthermore, let us say that the variables used by the CPU 106 included in the aforementioned controller 100 have been initialized to predetermined values, thereby operating the slot machine 13 in a normal state.

First, the CPU 106 included in the aforementioned controller 100 determines whether or not any coins inserted by the player are remaining (Step S1). More specifically, CPU 106 reads a credit number C stored in the RAM 110, and executes processing according to the credit number C. When the credit number C equals “0” (NO in Step S1), the CPU 106 terminates the routine without executing any processing, since it cannot start a game. When the credit number C is not less than “1” (YES in Step S1), the CPU 106 determines that coins remain as credits, and the CPU 106 moves the processing to Step S2.

In Step S2, CPU 106 determines whether or not a pushing operation has been applied to the spin bet repeat switch 24. When the switch 24 has been pushed and the CPU 106 receives an operation signal from the switch 24 (YES in Step S2), the CPU 106 moves the processing to Step S13. On the other hand, when the CPU 106 does not receive the operation signal from the switch 24 after a predetermined period of time elapses (NO in Step S2), the CPU 106 determines that the switch 24 has not been pushed and moves the processing to Step S3.

In the following Step S3, the CPU 106 sets the game conditions. Specifically, the CPU 106 determines the amount of coins bet on the active pay lines in this game based on the operation of the bet switch 23. Then, the CPU 106 determines the bet amount to be bet on the active pay lines based upon the number of times signals that indicate operation of the bet switch 23 have been received, and stores the bet amount thus determined in a predetermined memory area of the RAM 110. The CPU 106 reads the credit amount C stored in a predetermined memory area of the RAM 110, and subtracts the total bet amount, which is the sum of the aforementioned bet amounts, from the credit amount C thus read. Then, the CPU 106 stores the subtracted value in a predetermined memory area of the RAM 110. Subsequently, the CPU 106 moves the processing to Step S4.

In the following Step S4, the CPU 106 determines whether the start switch 25 is ON, and then, waits for the start switch 35 to be operated. Upon the start switch 25 being operated, and accordingly, upon the operation signal being input from the start switch 25 (in a case of “YES” in the determination processing in Step S4), the CPU 106 determines that the start switch 25 has been operated, and the flow proceeds to Step S5.

On the other hand, in step S13, the CPU 106 determines whether the credit number C is at least the total bet number in a previous game. In other words, the CPU 106 determines whether it can start a game in response to a pushing operation applied to the spin repeat bet switch 24. Specifically, in a case where the spin repeat bet switch 24 has been pushed, and accordingly, in a case where the operation signal has been input from the aforementioned switch 24, the CPU 106 reads the credit amount C and the bet amount bet to each of the active pay lines L1 to L9 in the previous game stored in the predetermined memory areas of the aforementioned RAM 110. Then, the CPU 106 determines whether the aforementioned credit amount C is at least the total bet amount bet in the previous game based upon the relation between the credit amount C and the bet amount thus read. When the CPU 106 determines that the credit number C is less than the total bet number (NO in Step S13), the CPU 106 terminates the routine without any processing, since it cannot start a game. On the other hand, in a case where determination has been made that the aforementioned credit amount C is at least the total bet amount bet in the previous game (in a case of “YES” in the determination processing in Step S13), the CPU 106 subtracts the total bet amount bet in the previous game from the aforementioned credit amount C, and stores the subtracted value in a predetermined area of the RAM 110. Subsequently, CPU 106 moves the processing to step S5.

In Step S5, CPU 106 performs processing for determining a combination of symbols. A specific description is provided below regarding the combination determination processing.

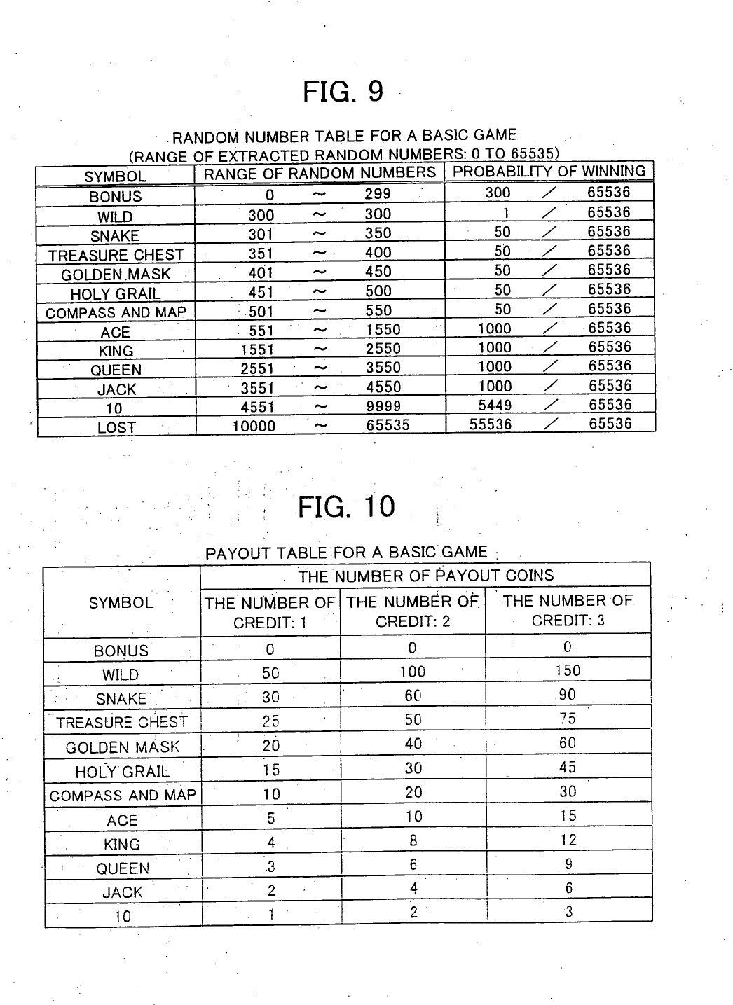

In the aforementioned combination determination processing, first, the CPU 106 determines the combinations of the symbols along the aforementioned active pay lines when they are stationary. Specifically, the CPU 106 issues a command for the random number generator 112 to generate a random number, thereby extracting a random number in a predetermined range (in a range of “0” to “65535” in the present embodiment) generated by the random number generator 112. The CPU 106 stores the random number thus extracted in a predetermined memory area of the RAM 110. It should be noted that a description is being provided in the present embodiment regarding an arrangement in which the random number is generated by the random number generator 112, which is a separate component from the aforementioned CPU 106. In addition, an arrangement may be made in which the random number is generated by computation processing by the CPU 106 without involving the random number generator 112. The CPU 106 reads a random number table for a basic table (see FIG. 9), and a payout table (see FIG. 10) for a basic table, each of which is stored in the ROM 108. Then, the CPU 106 stores the basic game random number table and the payout table thus read in a predetermined memory area of the RAM 110. It should be noted that the CPU 106 controls display of the symbols when they are stationary for each reel based upon the aforementioned random number table for a basic game. Furthermore, the CPU 106 reads the random number table for a basic game and the payout table for a basic game stored in the predetermined area of the aforementioned RAM 110. Then, the CPU 106 determines the combination of the symbols when they are stationary with respect to the aforementioned active pay lines with reference to the aforementioned random number table for a basic game, using the random number stored in the predetermined memory region of the aforementioned RAM 110 as a parameter. Upon determination of specified combinations for providing a prize, the CPU 106 stores the specified combination data for providing a prize thus determined in a predetermined memory area of the RAM 110. Then, the CPU 106 reads the random number and the specified combination data for providing a prize stored in the predetermined memory area of the RAM 110, and determines the combination of the symbols to be displayed to be stationary based upon the random number and the specified combination data for providing a prize thus read. In this stage, a symbol arrangement table (see FIG. 7) stored in the ROM 108 is read by the CPU 106. The symbol arrangement table thus read is stored in a predetermined memory area of the RAM 110, and used as reference data. The CPU 106 stores the data for the stationary symbols thus determined in a predetermined memory area of the RAM 110. Alternatively, an arrangement may be made in which the symbols when they are stationary are determined for each reel using the aforementioned random number table for a basic game.

Upon determination of the combination of the symbols when stationary with respect to the aforementioned active pay lines, the CPU 106 determines whether the combination of the symbols when they are stationary with respect to the active pay lines matches any one of the specified combinations for providing a prize. In a case where the combination of the symbols when they are stationary with respect to the active pay lines matches any one of the specified combinations for providing a prize, the CPU 106 activates a flag, which indicates that the player has won the prize that corresponds to the kind of specified combination for providing a prize, in order to provide the prize that corresponds with the specified combination of symbols with respect to the active pay lines for providing the prize. The activated flag, which indicates the player has won a prize, is stored in a predetermined area of the RAM 110 according to the instruction from the CPU 106. On the other hand, in a case where the combination of the symbols when they are stationary with respect to the active pay lines matches any one of the other combinations, i.e. the losing combinations, the CPU 106 does not activate the flag which indicates that the player has won a prize. Subsequently, CPU 106 moves the processing to Step S6.

Here, a random number table for basic games shown in FIG. 9 is explained. In the random number table for a basic game, a range of random numbers and the probability of winning are registered in association with each of the specified winning combinations. In processing for determining a symbol combination, for example, in a case where a random number is extracted from a range of numbers between “0” to “65535” is any one of the numbers in a range between “0” to “299”, the internal component of the slot machine 13 determines to generate a bonus combination as the final results of the basic game. In other words, the probability is “300/65536” that the combination of the symbols when they are stationary matches any one of the bonus combinations. On the other hand, in a case where a random number extracted from a range of numbers between “0” to “65535” is any one of the numbers in a range between “10000” to “65535”, the internal component of the slot machine 13 determines to generate other combinations, i.e. losing combinations, as the final results of the basic game. In other words, the probability is “55536/65536” that the combination of the symbols when they are stationary matches any one of the losing combinations.

FIG. 10 shows a payout table for a basic game. In the payout table for a basic game, the coin amount to be paid out is registered in association with each specified combination for providing a prize for each credit amount bet on one game. Therefore, let us consider a stage in which a determination is made whether the combination thus generated matches any one of the specified combinations for providing a prize. In this stage, let us consider a case in which the combination thus generated matches the combination “Wild”. In this case, in a case where the credit amount bet is “1”, 50 coins are paid out. In a case where the credit amount bet is “2”, 100 coins are paid out. In a case where the credit amount bet is “3”, 150 coins are paid out.

Referring to FIG. 8 again, in the following Step S6, the CPU 106 instructs the video reels 3A to 3E to start to rotate. Specifically, the CPU 106 displays an image which shows rotating the video reels 3A to 3E, in sequence or simultaneously, based upon the symbol arrangement table stored in the aforementioned RAM 110.

Upon displaying the image which shows the video reels 3A to 3E starting to rotate, the CPU 106 waits for a predetermined period of time to elapse (Step S7). After the predetermined period of time has elapsed (in a case of “YES” in the determination processing in Step S7), the CPU 106 instructs the video reels 3A to 3E to automatically stop rotating (Step S8). Specifically, the CPU 106 displays an image which shows the video reels 3A to 3E stopping rotation in sequentially or simultaneously such that the symbols when they are stationary, which correspond to the specified combinations for providing a prize determined in the aforementioned Step S5, are displayed within a display region that has a visually interactive relationship with the player. Subsequently, the CPU 106 moves the processing to Step S9.

In the following Step S9, the CPU 106 determines whether a predetermined symbol combination has been formed based upon the results of the combination determination processing performed in Step S5. Specifically, the CPU 106 makes this determination based upon the state of the flag that indicates whether the player has won a prize with respect to the active pay lines stored in the predetermined memory area of the aforementioned RAM 110. In a case where the flag, which indicates that the player has won a prize, has not been activated, i.e. in a case where the symbol combination matches any one of the “other” combinations, which are combinations other than the specified combinations for providing a prize (in a case of “NO” in the determination processing in Step S9), the CPU 106 determines that the specified combination for providing a prize has not been formed, and ends this routine. On the other hand, in a case where the flag, which indicates that the player has won a prize, has been activated, i.e. in a case where the symbol combination matches any one of the combinations other than the “other” combinations (in a case of “YES” in the determination processing in Step S9), the flow proceeds to Step 10 according to the instruction from the CPU 106.

In the following Step S10, the CPU 106 determines whether the symbol combination thus formed based upon the combination determination processing performed in Step S5 is a bonus combination. Specifically, the CPU 106 makes this determination based upon the state of the flag that indicates whether the player has won a prize with respect to the active pay lines stored in the predetermined memory area of the aforementioned RAM 110. In a case where the flag, which indicates that the player has won a prize, has been activated, and the specified combination for providing a prize is a “bonus” combination, the flow proceeds to Step 11 according to the instruction from the CPU 106. If not, the flow proceeds to Step 12.

In Step S11, CPU 106 executes the bonus game process (see FIG. 11). Upon finishing the processing in Step S11, the CPU 106 terminates the routine.

In a case where the flow has proceeded to Step S12, the CPU 106 pays out an amount of coins corresponding to the aforementioned specified combination for providing a prize. Specifically, the CPU 106 calculates the amount of coins to be paid out for the aforementioned specified combination for providing a prize, with reference to the payout table for a basic game (FIG. 10). The CPU 106 reads the credit amount stored in the aforementioned predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the sum thus stored on the credit amount display unit 49. Subsequently, the CPU 106 terminates the routine.

### a. FIRST EMBODIMENT OF THE PRESENT INVENTION

Referring to FIG. 11, bonus game processing 1 which is the first embodiment is explained.

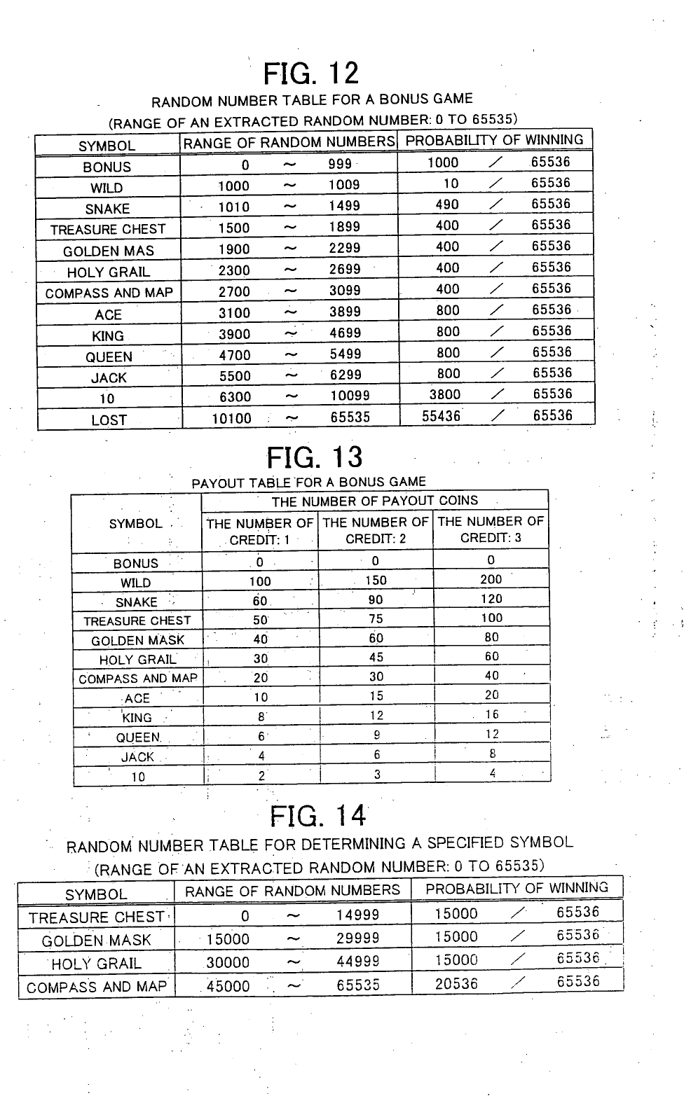

In Step S21, CPU 106 performs processing for determining a combination of symbols and then moves the processing to Step S22. A specific description regarding the processing for determining a combination of symbols is substantially the same as Step S5 described above in FIG. 8. The difference is that the table which the CPU 106 reads is a random number table for a Bonus game (see FIG. 12) stored in the ROM 108 and a payout table for a bonus game (see FIG. 13). Therefore, the random number table for a bonus game and the payout table for a bonus game, which are the differences from FIG. 8, are described as follows.

Here, the random number table for a bonus game shown in FIG. 12 is explained. In the random number table for a bonus game, a range of random numbers and the probability of winning are registered in association with each of the specified winning combinations. In a case where a random number extracted from a range of numbers between “0” to “65535” is any one of the numbers in a range between “3100” to “3899”, for example, the internal component of the slot machine 13 determines that the symbol combination is “Ace” combination, as the final result of the basic game. In other words, the probability is “800/65536” that the combination of the symbols when they are stationary matches any one of the “Ace” combinations.

The payout table for a bonus game shown in FIG. 13 is explained. In the payout table for a basic game, the coin amount to be paid out is registered in association with each specified combination for providing a prize for each credit amount bet on one game. Therefore, let us consider a stage in which a determination is made whether the combination thus generated matches any one of the specified combinations for providing a prize. In this stage, let us consider a case in which the combination thus generated matches the combination “Ace”. In this case, in a case where the credit amount bet is “1”, 10 coins are paid out. In a case where the credit amount bet is “2”, 15 coins are paid out. In a case where the credit amount bet is “13”, 20 coins are paid out.

Referring to FIG. 11 again, in Step S22, the CPU 106 performs processing for determining a specified symbol. Specifically, the CPU 106 determines a specified symbol with reference to a random number table for determining a specified symbol, which is described below. The CPU 106 stores the specified symbol data thus determined in a predetermined memory area of the RAM 110.

Here, the random number table for determining the specified symbol shown in FIG. 14 is explained. The random number table for determining the specified symbol is referred to when the CPU 106 determines the specified symbol. For example, in a case where the random number generated by the random number generator 112 is “33000”, the number belongs to a range of random numbers “30000 to 44999”, and thus, the specified symbol is determined as a “Holy Grail”.

Referring to FIG. 11 again, in Step S23, the CPU 106 processes starting rotation of a scroll line, and moves the processing to Step S24. The specific processing is substantially the same as the abovementioned Step S6 in FIG. 8.

Referring to FIG. 11 again, in Step S24, the CPU 106 determines whether a predetermined period of time has elapsed, and in a case where it has elapsed, the CPU 106 moves the processing to Step S25. When it has not elapsed, the CPU 106 moves the processing to Step S24. The specific processing is substantially the same as the abovementioned Step S7 in FIG. 8.

Referring to FIG. 11 again, in Step S25, the CPU 106 processes stopping rotation of a scroll line, and moves the processing to Step S26. The specific processing is substantially the same as the abovementioned Step S8 in FIG. 8.

In Step S26, the CPU 106 determines whether a specific symbol was rearranged in the display window of the first scroll line that is initially stopped. In a case where the CPU 106 determines that the specified symbol is rearranged in the display window of the first scroll line, the CPU 106 moves the processing to Step S27. In a case where the CPU 106 determines that the specified symbol is not rearranged in the display window of the first scroll line, the CPU 106 moves the processing to Step S31.

In addition, when the specified symbol is rearranged in the display window of the first scroll line, the CPU 106 activates a flag for providing a prize corresponding to specified symbols. More specifically, the CPU 106 activates the flag which is stored in a predetermined area of the RAM 110.

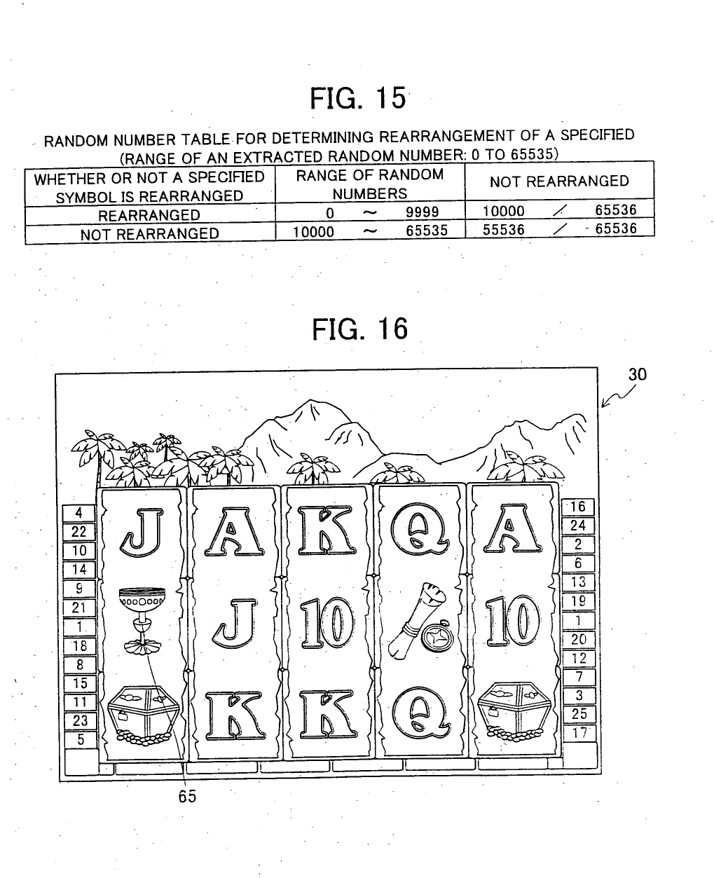

In Step S27, the CPU 106 determines whether the specified symbol is rearranged in the display window for each of the scroll lines other than the first scroll line. In a case where the CPU 106 determines that the specified symbol is rearranged in the display window for each of the other scroll lines, the CPU 106 moves the processing to the Step S28. In a case where the CPU 106 determines that the specified symbol is not rearranged in the display window for each of the other scroll lines, the CPU 106 moves the processing to the Step S31. Specifically, the CPU 106 determines whether a specified symbol is rearranged with reference to a random number table for determining rearrangement of a specified symbol, which is described below in FIG. 15. In addition, the processing in Step S27 is executed when a specified symbol does not correspond to winning combinations in association with the specified symbol rearranged in the display window of the first scroll line and the symbol rearranged in the display window of the other scroll line.

Here, the random number table for determining rearrangement of a specified symbol shown in FIG. 15 is explained. The random number table for determining rearrangement of a specified symbol is referred to when the CPU 106 determines whether a specified symbol is rearranged in the display window for each of the scroll lines other than the first scroll line. For example, in a case where the random number generated by the random number generator 112 is “5000”, the number belongs to a range of a random numbers “0 to 9999”, and thus it is determined that the specified symbol is “rearranged”.

Referring to FIG. 11 again, in Step S28, the CPU 106 determines whether the specified symbol is rearranged in the display window for each of the scroll lines other than the first scroll line. In a case where the CPU 106 determines that a specified symbol is rearranged in the display window for each of the other scroll lines, the CPU 106 moves the processing to Step S29. In a case where the CPU 106 determines that a specified symbol is not rearranged in the display window for each of the other scroll lines, the CPU 106 moves the processing to Step S31.

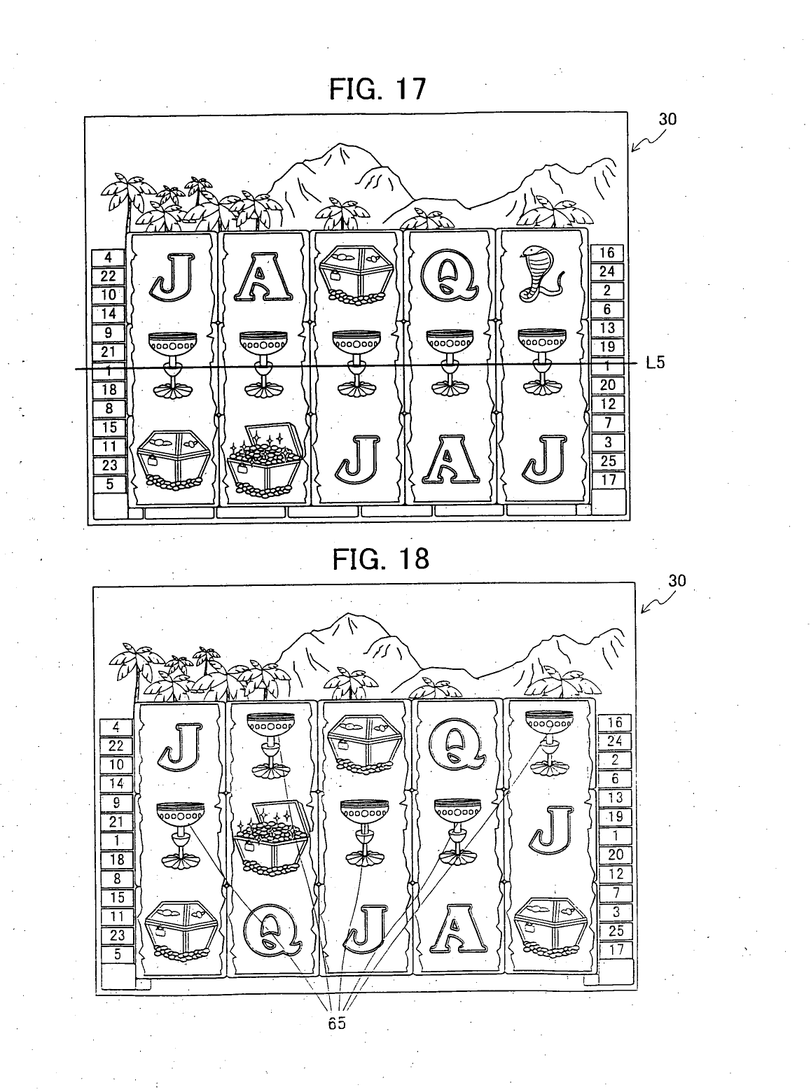

In Step S29, CPU 106 rearranges the specified symbol in the display window for each of the scroll lines other than the first scroll line, and then, moves the processing to Step S30. Specifically, the CPU 106 scrolls again the video reel corresponding to the other scroll lines among the video reel 3A to 3E, and then, rearranges the specified symbol (Holy Grail symbol) on the active pay line corresponding to the display position of the specified symbol rearranged in the display window of the first scroll line (see FIG. 17).

In addition, the specified symbol may be rearranged in the display windows of all the other scroll lines by scrolling again, without rearranging the specified symbol on the active pay line corresponding to the display position of the specified symbol rearranged in the display window of the first scroll line (see FIG. 18). Alternatively, the predetermined number of the specified symbols (for example, three) may be rearranged.

In Step S30, the CPU 106 awards a prize corresponding to the specified symbol. Specifically, when a flag for awarding a prize corresponding to a specified symbol is activated, the CPU 106 awards a prize corresponding to the specified symbol with reference to the payout table for a bonus game described above in FIG. 13. For example, if the specified symbol is Holy Grail, it pays 60 credits (in the case where the amount of credits bet is three). Upon finishing the processing in Step S30, the CPU 106 terminates the routine.

In Step S31, the CPU 106 pays out the amount of coins corresponding to a symbol combination when a predetermined symbol combination has been formed. Specifically, the CPU 106 calculates the amount of coins to be paid out for the aforementioned specified combination for awarding a prize, with reference to the payout table for a basic game (see FIG. 13). The CPU 106 reads the credit amount stored in the aforementioned predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the sum thus stored on the credit amount display unit 49. Subsequently, the CPU 106 terminates the routine.

FIG. 16 illustrates an example of the rendered image. FIG. 16 illustrates that the specified symbol (a Holy Grail symbol 65) is rearranged in the display window of the first scroll line that is initially stopped (for example, a video reel 3A shown in FIG. 3) in Step S26 shown in FIG. 11. The CPU 106 displays the image on the liquid crystal display 30 via the display/input controller 140.

FIG. 17 illustrates the example of the rendered image. FIG. 17 illustrates that the specified symbol (a Holy Grail symbol) is rearranged on the active pay line L5 by scrolling the scroll line again when it is stationary shown in FIG. 16. The CPU 106 displays the image on the liquid crystal display 30 via the display/input controller 140.

Although it is described in the first embodiment that the specified symbol (Holy Grail symbol 65) is rearranged by scrolling again on the active pay line corresponding to a display position of the specified symbol rearranged in the display window of the first scroll line, the present invention is not limited thereto and the specified symbol (holy Grail symbol 65) may be rearranged in the display windows of all of the scroll lines. Alternatively, the predetermined number of the specified symbols (for example, three) may be rearranged (not shown).

### b. SECOND EMBODIMENT OF THE PRESENT INVENTION

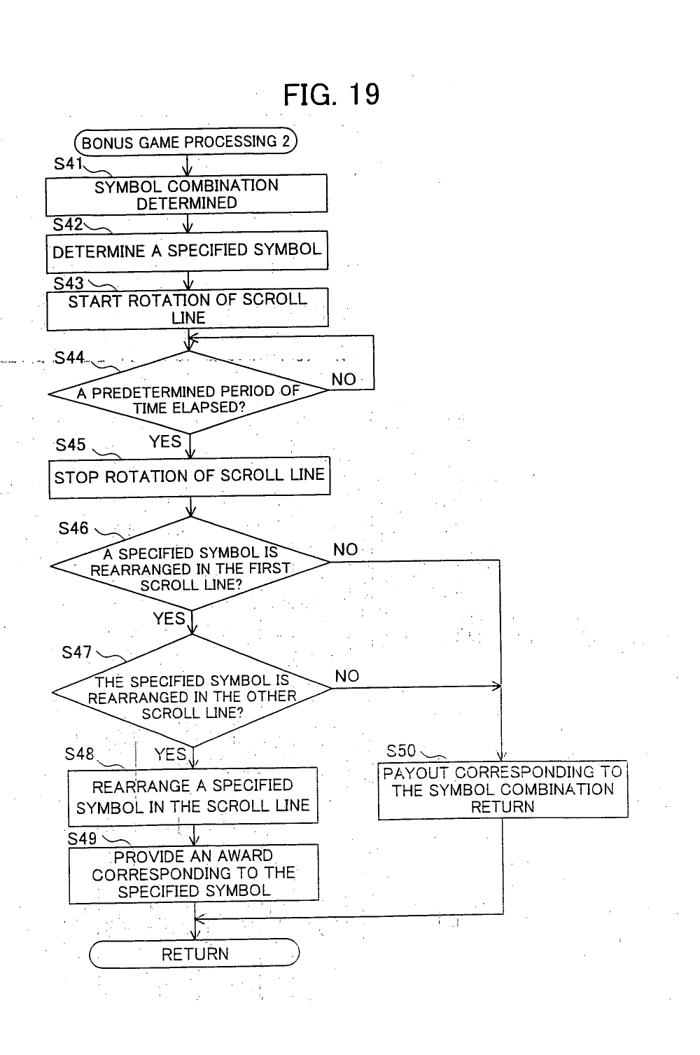

Referring to FIG. 19, a bonus game processing 2, which is the second embodiment of the present invention, is explained.

In Step S41, the CPU 106 performs processing for determining a symbol combination and then moves the processing to Step S42. The specific processing is substantially the same as the abovementioned Step S21 in FIG. 11.

Referring to FIG. 19 again, the CPU 106 performs a processing for determining a specified symbol. The specific processing is substantially the same as the abovementioned Step S22 in FIG. 11.

Referring to FIG. 19 again, in Step S43, the CPU 106 processes starting rotation of a scroll line, and moves the processing to Step S44. The specific processing is substantially the same as the abovementioned Step S6 in FIG. 8.

Referring to FIG. 19 again, and, in Step S44, the CPU 106 determines whether a predetermined period of time has elapsed. In a case where it has elapsed, the CPU 106 moves the processing to Step S45. In a case where it has not elapsed, the CPU 106 moves the processing to Step S44. The specific processing is substantially the same as the abovementioned Step S7 in FIG. 8.

Referring to FIG. 19 again, in Step S45, the CPU 106 processes stopping rotation of a scrolling line, and moves the processing to Step S46. The specific processing is substantially the same as the abovementioned Step S8 in FIG. 8.

Referring to FIG. 19, in Step S46, the CPU 106 determines whether the specified symbol is rearranged in the display window of the first scroll line which is initially stopped. In a case where the CPU 106 determines that the specified symbol is rearranged in the display window of the first scroll line, the CPU 106 moves the processing to Step S47. In a case where the CPU 106 determines that the specified symbol is not rearranged in the display window of the first scroll line, the CPU 106 moves the processing to Step S50.

In Step S47, the CPU 106 determines whether the specified symbol is rearranged in the display window for each of the scroll lines other than the first scroll line. In a case where, the CPU 106 determines that the specified symbol is rearranged in the display window for each of the other scroll lines, the CPU 106 moves the processing to Step S48. In a case where the CPU 106 determines that the specified symbol is not rearranged in the display window for each of the other scroll lines, the CPU 106 moves the processing to Step S50.

In addition, when the specified symbol is rearranged in the display window for each of the other scroll lines, the CPU 106 activates a flag for awarding a prize corresponding to specified symbols. More specifically, the CPU 106 activates the flag which is stored in a predetermined area of the RAM 110.

In Step S48, the CPU 106 determines whether a specific symbol was rearranged on the active pay line corresponding to a display position of the specified symbol rearranged in the display window of the first scroll line, and moves the processing to Step S49. Specifically, the CPU 106 scrolls again the video reel corresponding to the other scroll lines among the video reel 3A to 3E, rearranges the specified symbol on the active pay line, and then, stops scrolling the video reel again.

In Step S49, the CPU 106 awards a prize corresponding to the specified symbol. The specific processing is substantially the same as the abovementioned Step S30 in FIG. 11. Upon terminating the processing in Step S49, CPU 106 terminates the routine.

Referring to FIG. 19 again, in Step S50, when the predetermined symbol combination has been formed, the CPU 106 pays out the amount of coins corresponding to the symbol combination, which is the same as Step S31 described in FIG. 11. Upon terminating the processing in Step S50, CPU 106 terminates the routine.

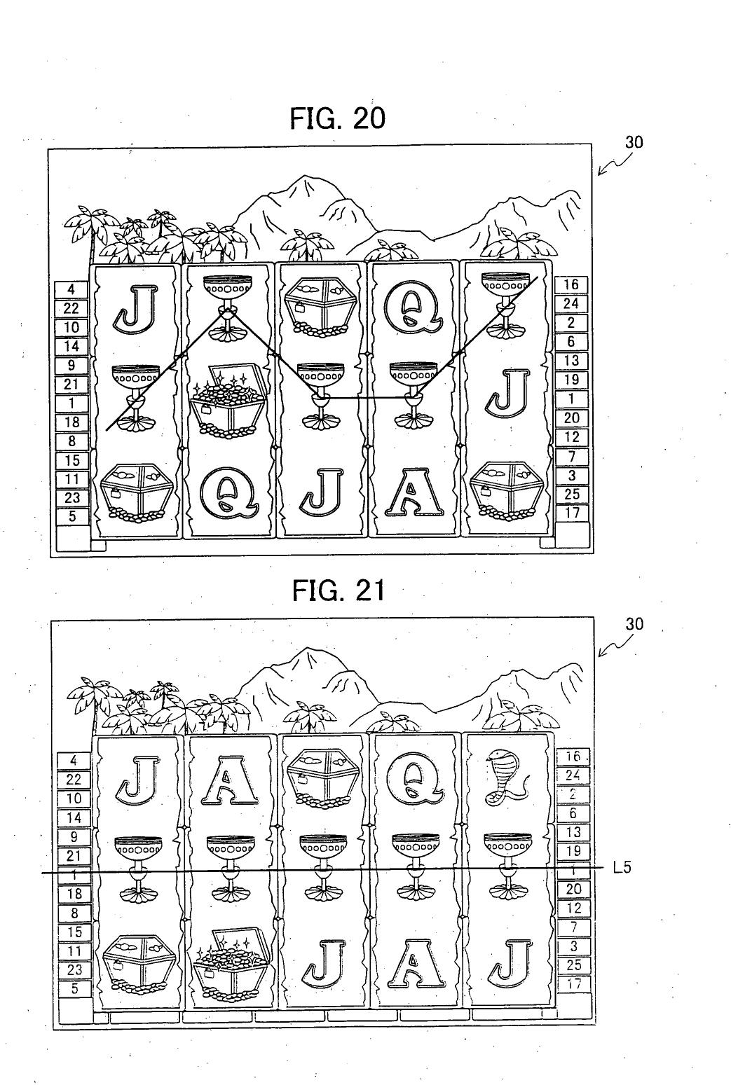

FIG. 20 illustrates an example of the rendered image. FIG. 20 illustrates that the specified symbol (Holy Grail symbol) is rearranged in the display window of the first scroll line that is initially stopped and that, when the specified symbol is rearranged in the display window of the other scroll line, a line linking the specified symbol (Holy Grail symbol) thus displayed is displayed as an active pay line. The CPU 106 displays the image on the liquid crystal display 30 via the display/input controller 140.

FIG. 21 illustrates an example of the rendered image. FIG. 21 illustrates that the specified symbol (Holy Grail symbol) is rearranged on the active pay line L5 by scrolling again the scroll line when it is stationary shown in FIG. 19. The CPU 106 displays the image on the liquid crystal display 30 via the display/input controller 140.

Although in the present embodiment, an example using a Holy Grail symbol as a specified symbol is explained, the present embodiment is not limited thereto, and the other symbols (for example, Ace, and the like) may be used for a specified symbol.

In addition, although in the present embodiment, an example applied to a video reel slot machine is explained regarding the present invention, the present embodiment is not limited thereto, and for example, the present invention may be applied to a mechanical slot machine.

Furthermore, although in the present embodiment, an example using a slot machine (a so-called casino machine) in which a reel is automatically stopped after being rotated without using a stop button is explained regarding the present invention, the present embodiment is not limited thereto, and for example, the present invention may be applied to a slot machine (a so-called Pachinko-slot machine) in which reels are stopped in the order by which a player stops the reels by hand using the stop button.

While the embodiments according to the present invention have been described as mentioned above, it is understood that many changes and modifications may be made therein without departing from the spirit and scope of the present invention.

What is claimed is:

1. A gaming machine, comprising:
a display device for displaying a plurality of types of symbols and a plurality of columns where the plurality of types of symbols is independently scrolled;
a memory for storing symbol data corresponding to the plurality of types of symbols;
an input device; and
a controller configured with logic to:
(a) start a game, receiving a signal from the input device, and cause the game to be switched to a predetermined game state when a game result satisfies a predetermined condition;
(b) determine in the switched game state whether a predetermined specific symbol has been arranged in a window of a first column that is first controlled to be stationary; and
(c) arrange a symbol different from the specific symbol in a window of another column when the specific symbol has been arranged in the window of the first column, and when a winning combination does not occur in combination with the specific symbol in the first column, cause another column to be scrolled again such that the winning combination is effective.

2. The gaming machine according to claim 1, wherein the predetermined game state is a bonus game.

3. A gaming machine, comprising:
a display device for displaying a plurality of types of symbols and a plurality of columns where the plurality of types of symbols is independently scrolled; and
a memory for storing symbol data corresponding to the plurality of types of symbols; and
a controller configured with logic to:
(a) start a game;
(b) cause the game to be switched to a predetermined game state depending on a result of the game;
(c) select specific symbol data from the symbol data stored in the memory when the game has been switched to the predetermined game state;
(d) cause the display device to display a scrolled image of the plurality of types of symbols for each of the plurality of columns;
(e) when the specific symbol data is arranged in a window of a first column that is first controlled to be stationary, determine whether the specific symbol has been arranged in a window of each column other than the first column; and
(f) when the specific symbol is arranged in the window of each column other than the first column, provide an award in accordance with the specific symbol.

4. The gaming machine according to claim 3, wherein the predetermined game state is a bonus game.

5. A gaming machine, comprising:
a display device for displaying a plurality of types of symbols, a plurality of columns where the plurality types of symbols is independently scrolled and predetermined pay lines; and
a memory for storing symbol data corresponding to the plurality of types of symbols; and
a controller configured with logic to:
(a) start a game;
(b) cause the game to be switched to a predetermined game state depending on a result of the game;
(c) select specific symbol data from the symbol data stored in the memory when the game has been switched to the predetermined game state;
(d) cause the display device to display a scrolled image of the plurality of types of symbols for each of the plurality of columns;
(e) when the specific symbol data is arranged in a window of a first column that is first controlled to be stationary, determine whether the specific symbol has been arranged in a window of each column other than the first column;
(f) when the specific symbol is arranged in the window of each column other than the first column, cause the display device to display a rescrolled image of each column other than the first column such that the specific symbol is rearranged on a pay line on which the specific symbol is arranged in the window of the first column;
(g) cause the display to stop rescrolling; and
(h) provide an award in accordance with the specific symbol.

6. The gaming machine according to claim 5, wherein the predetermined game state is a bonus game.

7. A gaming machine, comprising:
a display device for displaying a plurality of types of symbols and a plurality of columns where the plurality of types of symbols is independently scrolled; and
a memory for storing symbol data corresponding to the plurality of types of symbols; and
a controller configured with logic to:
(a) start a game;
(b) cause the game to be switched to a predetermined game state depending on a result of the game;
(c) select specific symbol data from the symbol data stored in the memory when the game has been switched to the predetermined game state;
(d) cause the display device to display a scrolled image of the plurality of types of symbols for each of the plurality of columns;
(e) when the specific symbol data is arranged in a window of a first column that is first controlled to be stationary, determine whether the specific symbol has been arranged in a window of each column other than the first column; and
(f) when the specific symbol is arranged in the window of each column other than the first column, cause the display device to display an image of pay line that connects each position of the specific symbol in the window of each column and provide an award in accordance with the specific symbol.

8. The gaming machine according to claim 7, wherein the predetermined game state is a bonus game.
